(19) United States
(12) Patent Application Publication
(10) Pub. No.: US 2012/0213440 A1
(43) Pub. Date: Aug. 23, 2012

(54) Systems and Methods for Automatically Identifying Shadows in Images

(75) Inventors: Marshall Tappen, Oviedo, FL (US); Jiejie Zhu, Orlando, FL (US)

(73) Assignee: University of Central Florida Research Foundation, Inc., Orlando, FL (US)

(21) Appl. No.: 13/298,378

(22) Filed: Nov. 17, 2011

Related U.S. Application Data
(60) Provisional application No. 61/416,049, filed on Nov. 22, 2010.

(51) Int. Cl. G06K 9/46; G06K 9/34

(52) U.S. Cl. 382/173

(57) ABSTRACT

In one embodiment, a system and method automatically identifying shadows in an image by segmenting the image into a plurality of discrete segments, measuring multiple features of each segment, the features being indicative as to whether the segment is or is not shadow, and automatically determining as to each segment whether the segment is or is not shadow based upon the individual feature measurements.

### CROSS-REFERENCE TO RELATED APPLICATION

This application claims priority to copending U.S. provisional application entitled, “Systems And Methods For Automatically Identifying Shadows In Images,” having Ser. No. 61/416,049, filed Nov. 22, 2010, which is entirely incorporated herein by reference.

### NOTICE OF GOVERNMENT-SPONSORED RESEARCH

This invention was made with Government support under Contract/Grant No.: 1047381, awarded by the National Geospatial-Intelligence Agency (NGA). The Government has rights in the claimed inventions.

### BACKGROUND

There are various circumstances in which it would be desirable to automatically identify and remove shadows in images, such as surveillance or intelligence images. For example, shadows can complicate feature detection, object recognition, and scene parsing. Although such shadows can be manually identified by a human being, manual identification is time consuming. An automated shadow identification process would therefore be preferable.

Automatic shadow identification is not difficult when the images at issue are color images. In such cases, shadows can be identified by assuming that the chromatic appearance of image regions does not change across shadow boundaries, while the intensity component of a pixel's color does. Such an assumption cannot be used, however, when the underlying image is monochromatic, which is often the case for intelligence images. As a result, shadows in monochromatic images are normally manually tagged by a human analyst when shadow identification is required.

In view of the above discussion, it can be appreciated that it would be desirable to have a system and method for automatically identifying shadows in images, including monochromatic images.

### BRIEF DESCRIPTION OF THE FIGURES

The patent or application file contains at least one drawing executed in color. Copies of this patent or patent application publication with color drawing(s) will be provided by the Office upon request and payment of the necessary fee.

The present disclosure may be better understood with reference to the following figures. Matching reference numerals designate corresponding parts throughout the figures, which are not necessarily drawn to scale.

FIG. 1 is an example monochromatic reference image.

FIGS. 2(a) and 2(b) are mean histograms of log illumination and local maximum, respectively.

FIG. 3 shows histograms of entropy values for different types of surfaces.

FIG. 4 shows an example of edge response for the reference image of FIG. 1.

FIG. 5 is a block diagram of an embodiment of a computer that can be used to perform automatic shadow identification.

FIG. 6 is a flow diagram that illustrates an embodiment of a method for automatically identifying shadows in an image.

FIGS. 7(a)-7(h) are various computer-generated images that illustrate various features of an image that can be measured to assist in the identification of shadows in an image.

FIGS. 8(a)-8(c) illustrate a reference image, a shadow probability map for the reference image, and a line segmentation, respectively.

FIGS. 9(a)-9(c) illustrate examples of shadow removal from monochromatic images.

### DETAILED DESCRIPTION

As described above, the automated shadow identification techniques used for multichromatic images are ineffective for monochromatic images. Disclosed herein, however, are systems and methods that can be used to automatically identify shadows in monochromatic images. More broadly, disclosed are systems and methods that can be used to automatically identify shadows in images, whether they are monochromatic or multichromatic. As is described in greater detail below, the shadow identification is based upon the evaluation of multiple image characteristics or “features.” Such features can include, for example, intensity, local maximum, smoothness, skewness, discrete entropy, edge response, gradient similarity, and texture similarity. In some embodiments, pixels and/or segments of the image are individually analyzed relative to one or more of the features and a determination is made as to whether the pixel and/or segment is or is not shadow based upon the results of the analysis. In some embodiments, the systems and methods further remove or attenuate the shadows after they have been identified to more clearly show objects in the captured scene.

In the following disclosure, various embodiments are described. It is to be understood that those embodiments are merely example implementations of the disclosed inventions. Accordingly, Applicant does not intend to limit the present disclosure to those particular embodiments.

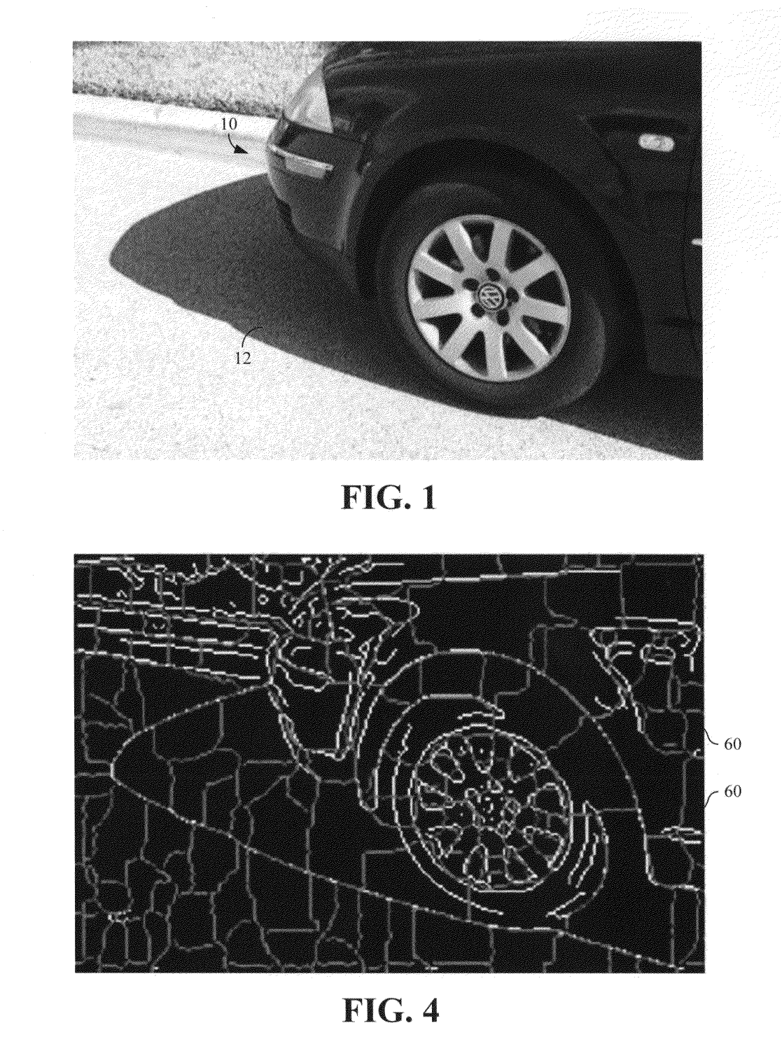

Shadow detection in monochromatic images is challenging because the monochromatic domain tends to have many objects that appear black or near black. For example, in the image of FIG. 1, the car 10 casts a dark shadow 12 that appears similar in appearance to the car's dark paint. Such dark objects complicate shadow recognition because shadows are expected to be relatively dark. As described herein, it has been determined that automatic shadow detection can be achieved by focusing on other characteristics or “features” of the underlying image. To that end, various shadow-containing monochromatic images were captured under various conditions to generate a database of images. Shadows in the images were manually tagged and the various features of the shadows were evaluated to determine what values for each feature is indicative of which condition, shadow or non-shadow.

Through the above-described process, various features were identified that can provide an indication or cue as to whether a pixel or segment of an image is or is not shadow. In particular, it was determined that different types of features can be used in the shadow detection analysis, including shadow-variant features that describe different characteristics in shadows and in non-shadows and shadow-invariant features that exhibit similar behaviors across shadow boundaries. Both of these types of features are useful because strong predictions of shadows are possible when complimentary cues are considered together. In some embodiments, the best performance is achieved by using both shadow-variant and shadow-invariant features, likely because lack of changes in shadow-invariant features provide valuable information about whether changes in shadow-variant features are actually caused by a shadow.

Shadow-variant features include intensity, local maximum, smoothness, skewness, discrete entropy, and edge response. Each of these features is discussed separately in the following paragraphs.

Intensity relates to the intensity of a given segment. Statistics can be gathered about the intensity of image segments because shadows are expected to be relatively dark. The intensity difference of neighboring pixels can be measured using their absolute difference. The difference in neighboring segments can be measured using L₁ norm between the histograms of intensity values. The feature vector can be augmented with the averaged intensity value and the standard deviation.

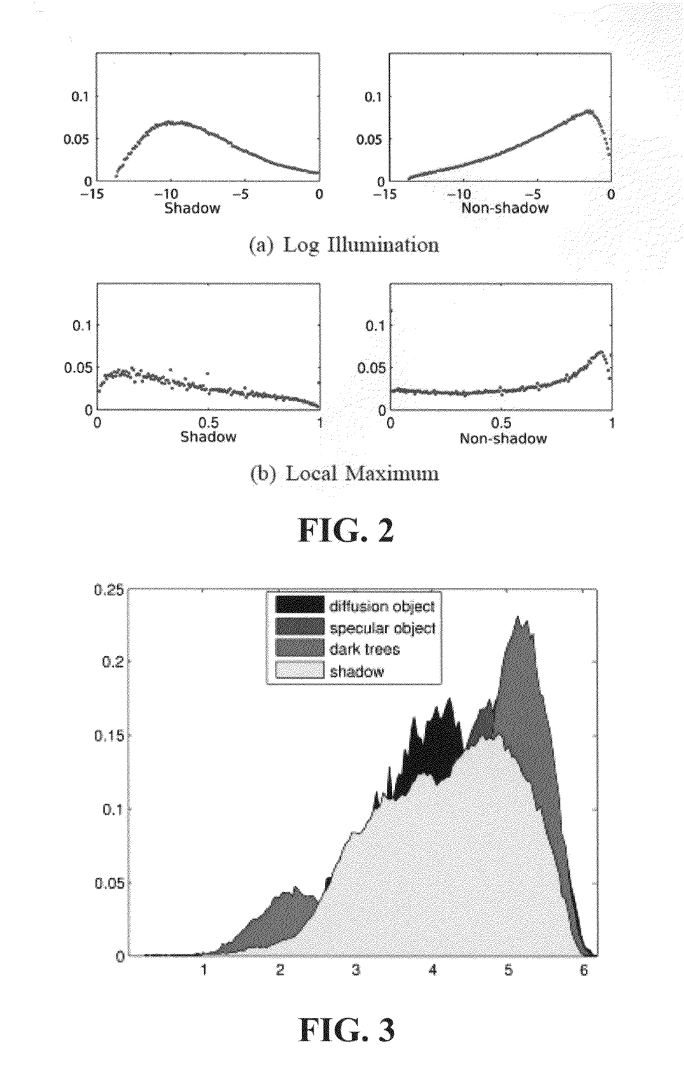

The local maximum, or local max, of an image segment is the maximum (brightest) value in the segment returned by oversegmentation. If shadows have values that are very low in intensity in a local patch, the local max value can be expected to be small. However, non-shadows often have values with high intensities and the local max value can be expected to be large. This cue can be captured, for example, by a local max completed at three pixel intervals. FIG. 2 illustrates example mean histograms of log illumination and local maximum. The histograms were generated from neighboring pairs of shadow/non-shadow segments using equal bin centers. The number of bins was set to 150. The mean histogram is plotted by gathering the histograms from all individual images in the dataset.

Smoothness relates to how locally smooth an image segment is. Shadows are often a smoothed version of their neighbors because shadows tend to suppress local variations on the underlining surfaces. This cue can be captured by subtracting a smoothed version of the image from the original version. Already smoothed areas will have small differences where as highly varied areas will have large differences. The standard deviations from neighboring segments can be used to measure the smoothness.

Skewness is a measure of the asymmetry of an image segment. Several statistical variables (mean, standard deviation, skewness, and kurtosis) were gathered and it was determined that a mean value of 1.77 for shadows and −0.77 for non-shadows in skewness. This indicates that the asymmetries in shadows and in non-shadows are different, which is a good cue for locating shadows. This odd order statistic is also found to be useful in extracting reflectance and gloss from natural scenes.

Discrete entropy is a measure of how similar pixels are within an image segment. It was determined that shadows have a different entropy value compared to that of near black objects and that entropy of diffuse objects is relatively small. This is because most black objects are textureless, which is also true in most natural scenes. The entropy of specular objects and the entropy of shadows have a mediate value, but appear slightly different at their peaks. The discrete entropy can be computed for each segment using the formula

$${E}_{i} = {\sum }_{i ∈ ω} - {p}_{i} \times {log}_{2} ( {p}_{i} ) \qquad ( 1 )$$

where ω denotes all the pixels inside the segment, pᵢ is the probability of the histogram counts at pixel i. FIG. 3 shows histograms of entropy values for different types of surfaces. As can be seen in those histograms, the discrete entropy of regions in shadow can vary widely, but the entropy of diffusion is concentrated toward higher values. This can be used to help distinguish shadows from such objects.

Edge response is another useful feature to consider. Because shadows quantize strong edge responses, edge responses are often small in shadows. FIG. 4 shows an example where most of the segments 60 in shadows have near zero edge response, while that of a specular object (the body of the car) has a strong edge response. The edge response cut can be calculated by summing up edge responses (computed using the Canny Edge method with a threshold setting to 0.01) inside a segment.

Shadow-invariant features include gradient similarity and texture similarity. Those features are discussed in the following paragraphs.

Gradient similarity is a measure of the difference between neighboring pixels. It can be assumed that transforming the image with a pixel-wise log transformation makes the shadow an additive offset to the pixel values in the scene. This leads one to expect that the distribution of image gradient values will often be invariant across shadow boundaries. The similarity between the distributions of a set of first order derivative of Gaussian filters in neighboring segments of the image can be measured to capture this cue. The similarity can be computed using the L₁ norm of the difference between histograms of gradient values from neighboring segments. It is assumed that transforming the image with a pixel-wise log transformation makes the shadow an additive offset to the pixel values in the scene. This leads one to expect that the distribution of image gradient will often be invariant across shadow boundaries.

Regarding texture similarity, it has been observed that the textural properties of surfaces change little across shadow boundaries. The textural properties of an image region can be measured by filtering a database of images with a bank of Gaussian derivative filters comprising eight orientations and three scales and then applying clustering to form 128 discrete centers. Given a new image, the texton is assigned as the histograms binned at these discrete centers. The similarity can also be measured using the L₁ norm of the difference between histograms of texton values from neighboring segments.

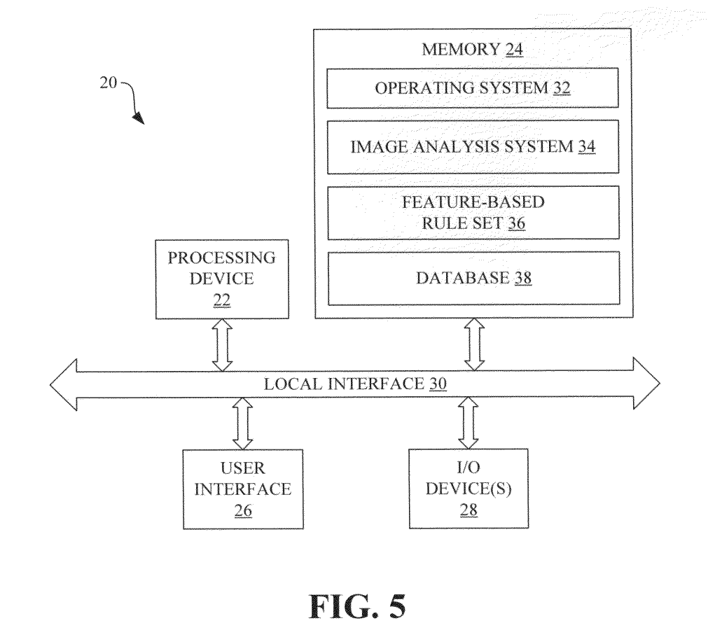

By evaluating some or all of the above-described features, each region or segment of an image can be automatically determined to be a shadow or not. FIG. 5 illustrates an example computer system or computer 20 that can be used to perform such automatic shadow identification. As indicated in that figure, the computer 20 comprises a processing device 22, memory 24, a user interface 26, and at least one input/output (I/O) device 28, each of which is connected to a local interface 30.

The processing device 22 can comprise a central processing unit (CPU) that controls the overall operation of the computer 20. The memory 24 includes any one of or a combination of volatile memory elements (e.g., RAM) and nonvolatile memory elements (e.g., hard disk, ROM, etc.) that store code that can be executed by the processing device 22 during image analysis.

The user interface 26 comprises the components with which a user interacts with the computer 20. The user interface 26 can comprise conventional computer interface devices, such as a keyboard, a mouse, and a computer monitor. The one or more I/O devices 28 are adapted to facilitate communications with other devices and may include one or more communication components such as a modulator/demodulator (e.g., modem), wireless (e.g., radio frequency (RF)) transceiver, network card, etc.

The memory 24 (i.e., a non-transitory computer-readable medium) comprises various programs (i.e., logic) including an operating system 32, an image analysis system 34, and a feature-based rule set 36. In addition, the memory 24 comprises a database 38, which can store one or more images that are to be evaluated. The operating system 32 controls the execution of other programs and provides scheduling, input-output control, file and data management, memory management, and communication control and related services. The image analysis system 34 is configured to analyze images to measure features of images for the purpose of collecting information that can be used to make shadow/non-shadow determinations. In some embodiments, the image analysis system 34 comprises part of a greater image processing package (not shown). As described below, the measured values can be evaluated relative to rules contained in the rule set 36 to facilitate such detection. In some embodiments, the rule set 36 can be incorporated into or form part of the image analysis system 34.

Various code (i.e., logic) has been described in this disclosure. Such code can be stored on any computer-readable medium for use by or in connection with any computer-related system or method. In the context of this document, a “computer-readable medium” is an electronic, magnetic, optical, or other physical device or means that contains or stores code, such as a computer program, for use by or in connection with a computer-related system or method.

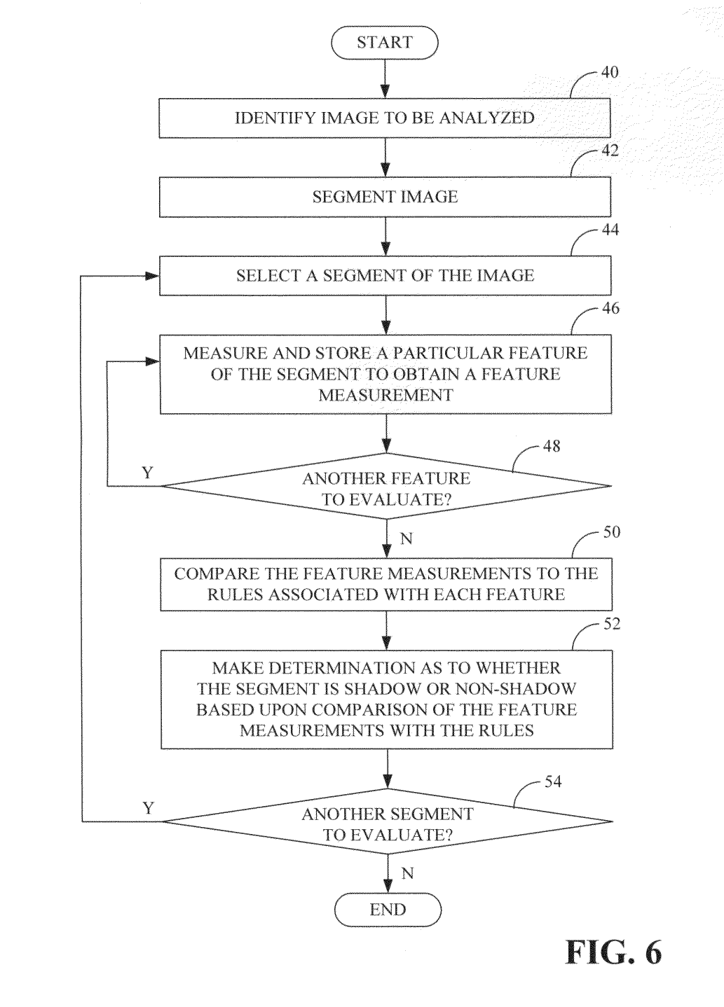

FIG. 6 illustrates an example embodiment of a method for identifying shadows of an image that can, for example, be performed by the computer 20 and image analysis system 34 of FIG. 5. Beginning with block 40, an image to be analyzed is identified. By way of example, the image can be selected from the database 38 by a user of the computer 20 so that the image analysis system 34 can identify the image. Referring next to block 42, the image analysis system 34 segments the image so that the image is divided into a plurality of separate segments that each can be evaluated as an independent region and/or an independent collection of pixels. The segmenting process respects the boundaries of the image and assembles groups of pixels with similar characteristics. An example of segmenting is illustrated in FIG. 4, which shows the image of FIG. 1 broken up into multiple segments 60.

Once the image has been segmented, a given segment of the image is selected, as indicated in block 44, and a particular feature of the segment, such as one of the features described above, is measured and stored, as indicated in block 46. To cite an example, the intensity of the segment is measured and stored. Referring next to decision block 48, it is determined whether there is another feature to measure. If so, flow returns to block 46 and a different feature is measured and stored. To cite a further example, the skewness of the segment is measured and stored. Once that new measurement has been made, flow again returns to block 48 and the next feature is measured and stored. This process continues until each feature that is to be considered has been measured.

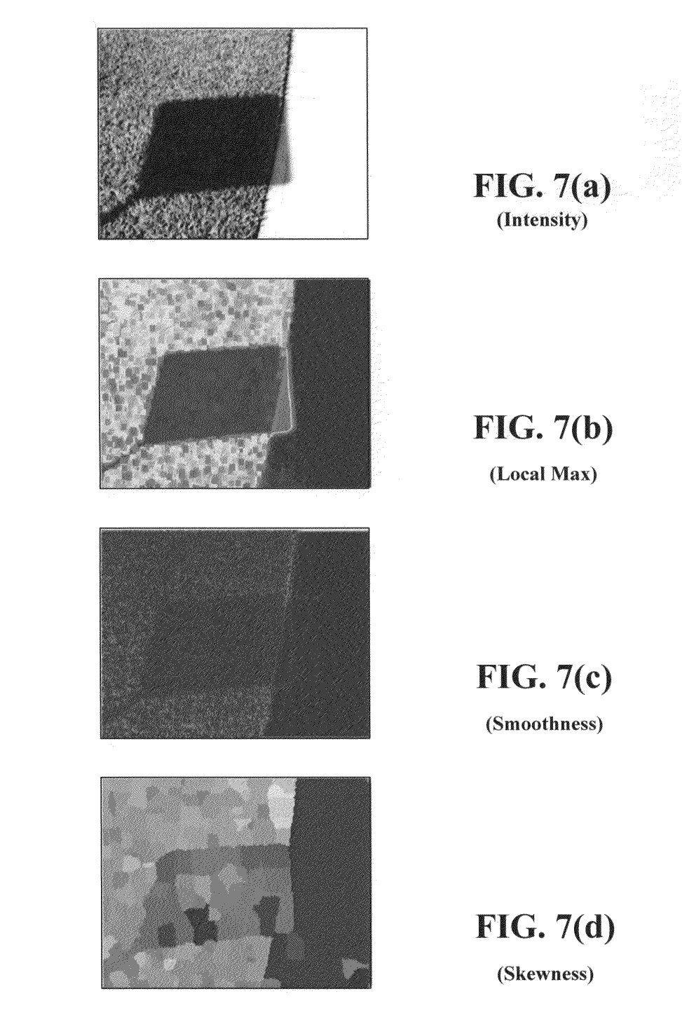

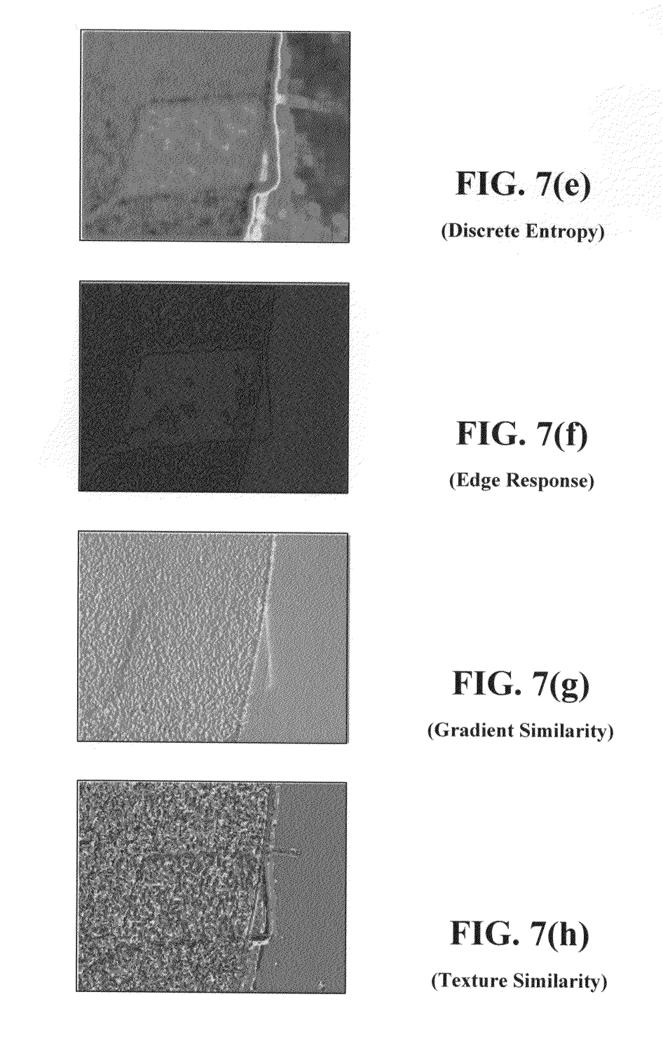

In some embodiments, each of intensity, local max, smoothness, skewness, discrete entropy, edge response, gradient similarity, and texture similarity is measured in the analysis. Measurement of each of these features is graphically illustrated in FIGS. 7(a)-7(h) relative to an image of a shadow cast on the ground by a road sign. Notably, some of the features can be measured on a segment-by-segment basis (e.g., local max, skewness, and edge response) while other features can be measured on a pixel-by-pixel basis (e.g., gradient similarity, intensity, texture similarity, smoothness, edge response). In some cases, the greatest accuracy of shadow detection may result when each of the above-described features is taken into consideration. It is noted, however, that not every one of those features must be considered in order to obtain acceptable results. For example, in some cases, consideration of intensity, local max, and skewness alone yield results that are nearly as accurate as those obtained when each of the above-mentioned features is considered. In some embodiments, the image analysis system can be configured to enable a user to individually select the features that the user wishes to be considered in the analysis.

After each considered feature has been measured, flow continues to block 50 at which each feature measurement is compared to its associated rule. As described above, the rules can have been generated using empirical data and determining what measurements for each feature are indicative of a shadow or a non-shadow. To cite an example, if the skewness of a segment was measured to be 2.0 and the rule associated with skewness is that a skewness measurement of greater than 1.0 is indicative of shadow, the skewness measurement weighs in favor of a shadow determination. If, on the other hand, the skewness was measured to be 0.1, the skewness measurement weighs in favor of a non-shadow determination.

Referring next to block 52, an overall determination as to whether the segment is shadow or non-shadow can be made relative to the application of the rules. In some embodiments, each considered feature is given the same weight in the overall determination. In other embodiments, the considered features are given different weights in the determination relative to their accuracy in identifying a possible shadow. Notably, further analysis can be performed when the overall determination does not strongly point to shadow or non-shadow. For instance, if some of the measured features suggest that the segment is shadow but other measured features suggest that the segment is non-shadow, the final determination as to the nature of the segment can be made relative to its neighboring segments. For example, if each of the neighboring segments is determined, using the above-described process, to be shadow, then it can, in some embodiments, be assumed that the segment under consideration is also shadow.

Once the shadow/non-shadow determination has been made as to the segment, flow returns to block 44 so that the next segment of the image can be evaluated. Flow continues in this manner (see decision block 54) until each segment of the image has been evaluated. At that point, various other actions can be performed, if desired, such as shadow removal or attenuation.

In the above-described flow, each individual feature is sequentially measured and then a determination as to what the features indicate is made. Of course, an equivalent method would be to sequentially evaluate each feature on an individual basis.

The features described above can also be roughly divided into two different types: (i) pixel level features that are calculated independently at each pixel. These include intensity, smoothness, gradient similarity, texture similarity, and edge response, and (ii) segment-level features that are computed over a small segment in the image. These include local max, skewness, and discrete entropy.

In the above-described process, the local statistical properties of different parts of the image are captured using a segment-based, rather than pixel-based, classification approach. In such a case, the input image is first oversegmented into regions, then each segment is classified as being in shadow or not. This oversegmention can be produced by first calculating the probability of boundary using the brightness and texture gradient, then segmenting with a watershed algorithm. In some embodiments, the classification can be performed using a boosted decision tree (BDT) classifier. The classifier can be trained using the GentleBoost training algorithm, which produces a linear combination of decision trees that are trained in a stage-wise fashion.

The features used to classify each image segment are a combination of the pixel features and the segment features. To make it easier for the classifier to analyze the distribution of pixel features in each segment, the feature vector describing each segment's pixel features is based on histograms. The pixel features in each segment can be represented with a 10 bin histogram of the values in each segment, along with the mean and standard deviation of the values in that segment, leading to 12 values per segment feature. Altogether, each segment is represented by a feature vector with 63 entries. There are 12 values for each of the five pixel features listed above, followed by three segment features.

In an experiment, a classifier was trained on a set of 30,000 segments randomly sampled from a training dataset, choosing an approximately equal number of positive and negative samples. The BDT classifier was constructed from 40 individual trees. Applied to all of the segments in an image, each tree returned a probability map showing the probability of each pixel being in shadows.

The classifier described above performs well using only local image data. It has been determined, however, that results can be further improved by using a conditional random field (CRF) model to propagate information from the classifier. This CRF model is created using the logistic random field (LRF) model. The LRF is essentially a logistic regression model, which is generalized to a conditional random field model.

In a classic logistic regression model, the probability that a data point, described by a feature vector f, should receive the label +1 is computed as

p(+1|f)=σ(w^{T}f) (2)

where the vector w is a vector of weights that defines a line in the feature space f. The function σ(•) is the logistic function:

$$σ ( z ) = \frac{1}{1 + exp ( - z )} \qquad ( 3 )$$

Logistic regression can be viewed as taking the linear function w^{T}f, which ranges from −∞ to +∞, and converting it into a probability, which ranges from 0 to 1.

The LRF model generalizes logistic regression by discriminatively estimating the marginal distribution over each pixel's label. This distribution is found by using a Gaussian CRF model to estimate a response image, r*, which is found by minimizing a cost function C(r; o).

$${r}^{*} = arg {min}_{r} C ( r ; o ) \qquad ( 4 )$$

To convert r* into the likelihood of a pixel i taking the label +1, the logistic function σ(r*) is used.

To improve on the results from the BDT classifier, the output of the trees compromising the BDT classifier can be used to create the vector f from Equation 2. To make it possible to directly incorporate the output of the BDT classifier into the LRF model, a new feature vector is created for each pixel. While the BDT model operates on segments, each pixel has an individual label in the LRF model. The vector f is created for each pixel by concatenating the output of each of the 40 trees in the BDT classifier when it is applied to the segment to which the pixel belongs. This 40-entry feature vector is augmented with the five pixel-level features listed above leading to a feature vector with 45 entries.

The cost function C(r; o) uses both the observations o and captures smoothness relationships between neighbors. To recognize shadows, C(r; o) can be defined as

$$C ( r ; o ) = {\sum }_{i} {w}_{i} ( o ; {θ}_{1 } ) {( {r}_{i} - 10 )}^{2} + {w}_{i} ( o ; {θ}_{2 } ) {( {r}_{i} + 10 )}^{2} + {w}_{i} ( o ; {θ}_{3 } ) {\sum }_{〈 i , j 〉} {( {r}_{i} - {r}_{j} )}^{2} \qquad ( 5 )$$

Each term rᵢ refers to the entry pixel i in the response image r. The first two terms in the right side pull each pixel to either −10 or +10 in the response image r*. While the response image should technically vary between −∞ to +∞, setting a particular pixel to a σ(+10) gives the probability of 1−(4×10⁻⁵). This is sufficiently close to 1. The functions wᵢ(•) are functions that assign a weight to the different terms in C(r; o). The weight assigned to a particular term at pixel i is

wᵢ(o;θₖ)=exp(θₖ^{T}fᵢ) (6)

where fᵢ is a vector of features extracted from the area surrounding pixel i. This vector contains the features described above. The vector θₖ is the parameter vector for term k.

During training, the vectors θ₁, θ₂, θ₃ are concatenated into a vector θ. This vector is optimized by minimizing the sum of the negative log-likelihood across the images in the training set. For a single image, this criterion is defined as L(θ) as

$$L ( θ ) = [ {\sum }_{i} log ( 1 + exp ( - {t}_{i} {r}_{i} ) ) ] + λ {θ}^{T} θ \qquad ( 7 )$$

where tᵢ is the ground-truth label of each pixel, such that tᵢε{−1,+1}, and the second term is a quadratic regularization term used to avoid overfitting, and λ is manually set to 10⁻⁴.

In this loss function, L(θ) depends on θ via rᵢ. A standard gradient descent method can be used to iteratively update the parameters θ, which are all initialized at zero. Each feature is normalized into the range [−1,+1].

The details of the gradient computation of Equation (7) and the computation of r* using a matrix representation is described below.

The cost function C(r; o) can be rewritten in a matrix representation by (the upper bold letter represents a matrix)

C(r;o)=(Ar−b)^{T}W(o,θ)(Ar−b) (8)

where A is a block matrix composed by stacking matrix representations of the terms from Equation 5, r is the response image, and W is a diagonal weighting matrix by concatenating wᵢ(•).

The actual cost function used in learning is an augmented version of Equation 5. In addition to the final smoothing term in Equation 5, smoothing terms offset from each pixel can be used. In addition to terms penalizing the horizontal and vertical differences at every pixel i in the image, both of those differences can be penalized at all locations in a 3×3 window around i. The purpose of this is to make it possible for the feature information at i to affect neighboring smoothing terms. Because Equation 8 is a quadratic function, the response image can be computed using pseudo-inverse:

r*=(A^{T}W(o,θ)A)⁻¹A^{T}W(o,θ)b (9)

The criterion in Equation 7 can be differentiated with respect to θ using matrix calculus:

$$\begin{matrix}\frac{\partial L ( θ )}{\partial θ} = \frac{\partial L ( θ )}{\partial {r}^{*}} \frac{\partial {r}^{*}}{\partial θ} & ( 10 ) \\ \frac{\partial L ( θ )}{\partial {r}^{*}} = \frac{- exp ( - {r}^{*} )}{1 + exp ( - {r}^{*} )} + ( 1 - t ) + 2 λ θ & ( 11 ) \\ \frac{\partial {r}^{*}}{\partial θ} = \frac{\partial {( {A}^{T} W ( o , θ ) A )}^{- 1} {A}^{T} W ( o , θ ) b}{\partial θ} & ( 12 )\end{matrix}$$

To evaluate the performance of BDT+LRF in locating the shadows, 123 images were selected as training data. Those images were selected so that the shadow is clearly outlined in each image. The pixels that identified as shadows were then compared with the ground truth shadow masks associated with each image. Overall, it was determined that BDT+LRF, combining a local classifier and a global smoothness classifier, performance superior in most cases in terms of accuracy and consistency.

The evaluation was divided into two sets. The first set includes three comparisons using monochromatic based features: different types of features, different classification models, and different levels of over-segmentations. In the second set, the performance was compared using monochromatic features and chromatic features.

For all the comparisons, the accuracy computed using

$$\frac{T P}{T P + F P + F N} .$$

True Positive, TP, is measured as the number of pixels inside the mask. False Positive, FP, is measured as the number of pixels outside the mask. False Negative, FN, is measured as the number of pixels falsely located outside the mask. The true negative term was dropped because a majority of the pixels in the image are not in shadow, which might have biased the results. Dropping the true negative term can also help one understand the performance difference between classifiers focused on the shadows.

Once a per-pixel probability map denoting the trust of a pixel is in shadows is developed, a specific threshold value can be assigned for a pixel to be considered as a shadow pixel. For each threshold, the overall numerical accuracy of classifying shadow pixels can be computed. The highest accuracy obtained across all thresholds is reported below. In the investigation, 20 different thresholds were experimented with. The threshold values ranged between 0 and 1, both inclusive, with intervals of 0.05.

Overall, the results showed that the features can be successfully used to identify shadows. In addition, it was determined that BDT integrated with LRF using two combined levels of segments achieves acceptable results with accuracy at 43.7%; skewness, entropy and edges are very useful features; several combinations of the features, such as all shadow-variant features with edge and all shadow-variant features with entropy and edge, achieved best accuracy in our dataset; and the proposed chromatic features perform superior than the monochromatic feature.

Once a shadow within an image has been detected, it can be automatically removed or attenuated. An example method for removing/attenuating a shadow can comprise the following steps:

1) Detect edges in the binary shadow map;

2) At each pixel on a shadow edge, identify horizontal and vertical boundary regions lying on lines intersecting the pixel;

3) For each boundary region, fit a function that models the shadow gradients in that region;

4) Refine parameters of these shadow functions using an MRF;

5) Use optimized model of shadow gradients at each point to cancel image derivatives caused by shadows; and

6) Recover the shadow-free image by inverting the remaining derivatives.

The above shadow removal method is based on two assumptions. The first assumption is that the observed image is the product of a reflectance and shadow image. Formally the observed image I can be expressed as,

I(x,y)= [symbol] (x,y)× [symbol] (x,y) (13)

where [symbol] is a shadow-free image, that could include illumination effects beside shadows and [symbol] is the shadow image being estimated.

The second assumption is that image derivatives can be classified as belonging to either the reflectance image or the shadow image, but not both. This assumption makes it possible to remove a shadow by canceling the derivatives around that shadow. It is believed that this is a reasonable assumption because strong shadow boundaries and reflectance edges rarely occur at the same point, though in some situations an occlusion edge may also lie on the boundary of a cast shadow.

Once the shadow identification system described above has produced the shadow map, the shadows can be removed by canceling out the derivatives caused by the shadow. In natural scenes, a shadow boundary will typically be soft and span several pixels. This makes it necessary to cancel multiple shadow derivatives in the region of the shadow boundary. To do this, a function is fit to the shadow derivatives along boundary.

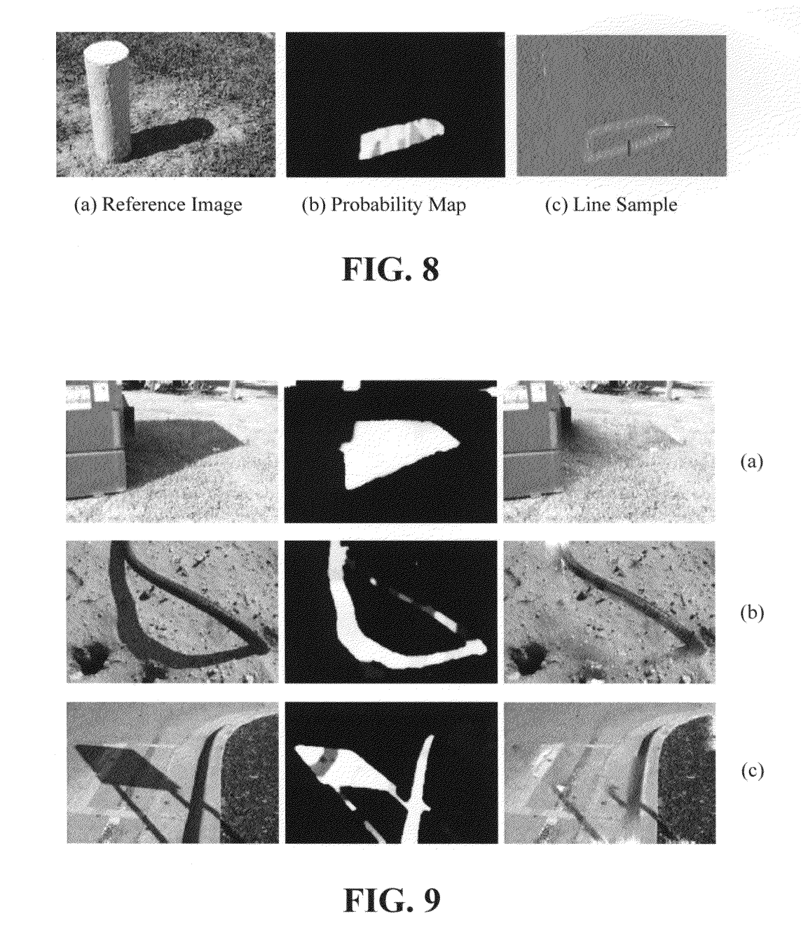

This shadow function is fit along vertical or horizontal lines that intersect a shadow boundary. This process is illustrated in FIGS. 8(a)-8(c). FIG. 8(a) is a reference image, FIG. 8(b) is a shadow probability map associated with the reference image, and FIG. 8(c) shows horizontal (red) and vertical (blue) line segments (a pair of lines provided for every pixel on the shadow boundary). While the appropriate length of this line can vary depending on the illumination and geometry of the scene, it has been determined empirically that extending the line five pixels on either side of the boundary works well.

The shadow gradients are fit with a Gaussian function of the form

$$f = A * exp ( \frac{- {( x - μ )}^{2}}{2 * {σ}^{2}} ) \qquad ( 14 )$$

where μ is the center location of the function, a controls the width of the lobe, and A is a scaling constant. These values are estimated by a least square approach, where the distance between the shape of the Gaussian is minimized with the original gradient shape. As will be discussed below, these values will be further optimized. It has been determined that this function is simpler to work with than the function used to model shadow derivatives, but performs comparably.

It should be emphasized this function is not being fitted as a distribution, but instead the shape of the function is being used as a good approximation to the characteristic shape of image derivatives around a shadow boundary. When the shadow is canceled, a new derivative image will be computed by pixel-wise subtracting the shadow function from the derivative image. This new derivative image will be used to compute the shadow-free image.

The Gaussian shadow function is optimized to fit the gradients in the line. One goal in fitting this function is to preserve texture in the image by ensuring that the area around the shadow boundary has a similar texture to the regions around it. This goal is expressed computationally through a distribution on image derivatives in non-shadow areas. The shadow function parameters, A, μ, and σ, are optimized to maximize the probability of the image derivatives remaining after shadow cancellation. Formally, if p(x) is a distribution over a vector of pixel values, then the optimization over parameters is

$${min}_{A , μ , sigma} - log p ( ( y - f ( A , μ , σ ) ) \qquad ( 15 )$$

where y is a vector of pixels extracted around a shadow boundary point as described above. The function ƒ(A, μ, σ) is the shadow function described in the previous section, with the difference y−ƒ(A, μ, σ) being the image derivatives remaining after the shadow boundary is canceled.

In practice, the pixels in the vector are treated as independent Gaussian variables when defining p(x). This makes p(x) have the form

$$p ( x ) = {\prod }_{i} 𝒩 ( {x}_{i} ; {μ}_{0} , {σ}_{0} ) \qquad ( 16 )$$

where the product is over all pixels in the vector. The distribution parameters μ₀ and σ₀ are calculated from regions that are an additional six pixels from the end of the original line region.

To insure the local smoothness while maximizing p(x), the consistency of the parameters A, μ, and σ can be enforced from neighboring line segments. This leads to the optimization criterion:

$$\begin{matrix}L = {\sum }_{i} log p ( x ) + & ( 17 ) \\ λ {\sum }_{〈 i , j 〉} ( {( {A}_{i} - {A}_{j} )}^{2} + {( {μ}_{i} - {μ}_{j} )}^{2} + {( {σ}_{i} - {σ}_{j} )}^{2} ) ) & ( 18 )\end{matrix}$$

The weight λ is set to 0.1. The L can be minimized using the standard gradient descent method.

After estimating the shadow functions and recovering the shadow-free gradients, they are re-integrated by iteratively solving a Laplace equation.

Examples of shadow removal results is shown in FIGS. 9(a)-9(c). In each example, the reference image, probability map, and shadow removal result are shown in sequence.

Claimed are:

1. A method practiced by a computer for automatically identifying shadows in an image, the method comprising the computer:
segmenting the image into a plurality of discrete segments;
measuring multiple features of each segment, the features being indicative as to whether the segment is or is not shadow; and
automatically determining as to each segment whether the segment is or is not shadow based upon the individual feature measurements.

2. The method of claim 1, wherein the features include one or more of intensity, local maximum, smoothness, skewness, discrete entropy, edge response, gradient similarity, and texture similarity.

3. The method of claim 1, wherein the features include each of intensity, skewness, and local maximum.

4. The method of claim 1, wherein segmenting comprises assembling groups of image pixels having similar characteristics.

5. The method of claim 1, wherein measuring multiple features comprises evaluating histograms of each of the features.

6. The method of claim 1, wherein determining whether the segment is or is not shadow comprises comparing each measured feature to a rule associated with that feature that identifies whether the measured feature is indicative of shadow or non-shadow.

7. The method of claim 1, further comprising automatically removing or attenuating shadows automatically identified in the image.

8. A non-transitory computer-readable medium that stores an image analysis system for automatically identifying shadows in an image, the system comprising:
logic configured to segment the image into a plurality of discrete segments;
logic configured to measure multiple features of each segment, the features being indicative as to whether the segment is or is not shadow; and
logic configured to automatically determine as to each segment whether the segment is or is not shadow based upon the individual feature measurements.

9. The computer-readable medium of claim 8, wherein the features include one or more of intensity, local maximum, smoothness, skewness, discrete entropy, edge response, gradient similarity, and texture similarity.

10. The computer-readable medium of claim 8, wherein the features include each of intensity, skewness, and local maximum.

11. The computer-readable medium of claim 8, wherein the logic configured to segment comprises logic configured to assemble groups of image pixels having similar characteristics.

12. The computer-readable medium of claim 8, wherein the logic configured to measure multiple features comprises logic configured to evaluate histograms of each of the features.

13. The computer-readable medium of claim 8, wherein the logic configured to determine whether the segment is or is not shadow comprises logic configured to compare each measured feature to a rule associated with that feature that indicates whether the measured feature is indicative of shadow or non-shadow.

14. The computer-readable medium of claim 8, further comprising logic configured to automatically remove or attenuate shadows automatically identified in the image.

15. A computer comprising:
a processor; and
memory that stores an image analysis system for automatically identifying shadows in an image, the system comprising logic configured to segment the image into a plurality of discrete segments, logic configured to measure multiple features of each segment, the features being indicative as to whether the segment is or is not shadow, and logic configured to automatically determine as to each segment whether the segment is or is not shadow based upon the individual feature measurements.

16. The computer of claim 15, wherein the features include one or more of intensity, local maximum, smoothness, skewness, discrete entropy, edge response, gradient similarity, and texture similarity.

17. The computer of claim 15, wherein the features include each of intensity, skewness, and local maximum.

18. The computer of claim 15, wherein the logic configured to measure multiple features comprises logic configured to evaluate histograms of each of the features.

19. The computer of claim 15, wherein the logic configured to determine whether the segment is or is not shadow comprises logic configured to compare each measured feature to a rule associated with that feature that indicates whether the measured feature is indicative of shadow or non-shadow.

20. The computer of claim 15, wherein the image analysis system further comprises logic configured to automatically remove or attenuate shadows automatically identified in the image.
